(19) United States
(12) Patent Application Publication
(10) Pub. No.: US 2024/0243302 A1
(43) Pub. Date: Jul. 18, 2024

(54) POWER GENERATION CELL AND FUEL CELL STACK

(71) Applicant: HONDA MOTOR CO., LTD., TOKYO (JP)

(72) Inventors: Satoshi OYAMA, WAKO-SHI (JP); Takuro OKUBO, WAKO-SHI (JP); Yukihito TANAKA, WAKO-SHI (JP); Keisuke ANDO, WAKO-SHI (JP); Yutaka EBATO, WAKO-SHI (JP); Natsumi IIZUKA, WAKO-SHI (JP)

(21) Appl. No.: 18/406,493

(22) Filed: Jan. 8, 2024

(30) Foreign Application Priority Data
Jan. 13, 2023 (JP) 2023-003446

(51) Int. Cl. H01M 8/0258; H01M 8/0273; H01M 8/0284; H01M 8/04029; H01M 8/1004

(52) U.S. Cl. CPC H01M 8/0258; H01M 8/0273; H01M 8/0284; H01M 8/04029; H01M 8/1004

(57) ABSTRACT

A power generation cell of a fuel cell stack includes a resin-framed membrane electrode assembly, a first separator, and a second separator. A second gas flow field for allowing a reactant gas to flow along an electrode surface of the membrane electrode assembly is formed on the second separator, and a first connection flow path in communication with an oxygen-containing gas supply passage is formed on the first separator, and a first through-hole connecting the second gas flow field and the first connection flow path to each other is formed in the frame member.

### CROSS-REFERENCE TO RELATED APPLICATIONS

This application is based upon and claims the benefit of priority from Japanese Patent Application No. 2023-003446 filed on Jan. 13, 2023, the contents of which are incorporated herein by reference.

### BACKGROUND OF THE INVENTION

### Field of the Invention

The present invention relates to a power generation cell and a fuel cell stack.

### Description of the Related Art

In recent years, research and development have been conducted on fuel cells that contribute to energy efficiency in order to ensure that more people have access to affordable, reliable, sustainable and modern energy.

JP 2010-287452 A discloses a power generation cell of a fuel cell stack. The power generation cell includes a resin-framed MEA, a first separator stacked on one surface of the resin-framed MEA, and a second separator stacked on the other surface of the resin-framed MEA. An oxygen-containing gas supply passage, an oxygen-containing gas discharge passage, a fuel gas supply passage, and a fuel gas discharge passage are formed in the first separator and the second separator to extend through the first separator and the second separator in the stacking direction.

The first separator has a first flow field for allowing the oxygen-containing gas to flow along a cathode of the resin-framed MEA. The first flow field is connected to the oxygen-containing gas supply passage and the oxygen-containing gas discharge passage formed in the first separator. The second separator has a second flow field for allowing the fuel gas to flow along an anode of the resin-framed MEA. The second flow field is connected to the fuel gas supply passage and the fuel gas discharge passage formed in the second separator.

### SUMMARY OF THE INVENTION

In the above-described power generation cell, the degree of freedom in layout of the flow paths formed in the separators cannot be increased.

An object of the present invention is to solve the aforementioned problem.

According to one aspect of the present invention, a power generation cell includes: a resin-framed membrane electrode assembly including a membrane electrode assembly and a resin frame provided on an outer periphery of the membrane electrode assembly; a first separator stacked on a first surface of the resin-framed membrane electrode assembly; a second separator stacked on a second surface of the resin-framed membrane electrode assembly; and a reactant gas passage extending through the first separator and the second separator to allow a reactant gas to flow in a stacking direction, wherein the second separator includes a reactant gas flow field configured to allow the reactant gas to flow along an electrode surface of the membrane electrode assembly, the first separator includes a connection flow path in communication with the reactant gas passage, and the resin frame includes a through-hole connecting the reactant gas flow field and the connection flow path to each other.

Another aspect of the present invention is a fuel cell stack in which a plurality of the above-described power generation cells are stacked.

According to the present invention, the degree of freedom in layout of the flow field formed in the second separator can be increased.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an exploded perspective view with partial omission of a fuel cell stack according to the present invention;

FIG. 2 is a plan view of a first separator;

FIG. 3 is a plan view of a second separator;

FIG. 4 is a partially enlarged plan view of an oxygen-containing gas supply passage and its vicinity of a power generation cell;

FIG. 5 is a cross-sectional view taken along line V-V of FIG. 4;

FIG. 6 is a partially enlarged plan view of an oxygen-containing gas discharge passage and its vicinity of the power generation cell; and

FIG. 7 is a cross sectional view taken along line VII-VII of FIG. 6.

### DETAILED DESCRIPTION OF THE INVENTION

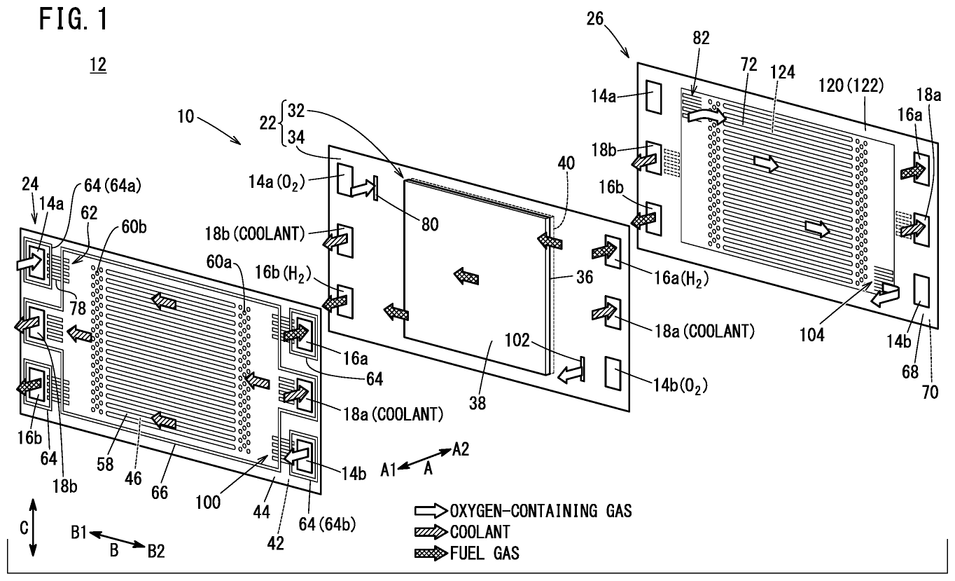

A power generation cell 10 and a fuel cell stack 12 according to an embodiment of the present invention will be described below with reference to the drawings. As shown in FIG. 1, the fuel cell stack 12 according to the present embodiment is formed by stacking a plurality of power generation cells 10 in a thickness direction (arrow A direction). The fuel cell stack 12 is mounted, for example, as a vehicle incorporated fuel cell stack in a fuel cell electric vehicle (not shown). The fuel cell stack 12 may be mounted on a stationary body including the ground. It should be noted that the stacking direction of the plurality of the power generation cells 10 may be oriented in either the horizontal direction, or the gravity direction.

The power generation cell 10 has a laterally elongated rectangular shape. The shape of the power generation cell 10 is not particularly limited, and may be formed in a vertically elongated rectangular shape or a square shape, for example. The power generation cell 10 generates power by electrochemical reactions between an oxygen-containing gas as one of the reactant gases and a fuel gas as the other of the reactant gases. The fuel gas is, for example, a hydrogen-containing gas. A coolant for cooling the power generation cell 10 flows through the power generation cell 10. The coolant is, for example, pure water, ethylene glycol, oil, or the like.

An oxygen-containing gas supply passage 14a, an oxygen-containing gas discharge passage 14b, a fuel gas supply passage 16a, a fuel gas discharge passage 16b, a coolant supply passage 18a and a coolant discharge passage 18b are formed to extend through each of the power generation cells 10 in the stacking direction (arrow A direction).

The oxygen-containing gas is supplied to the plurality of power generation cells 10 from the oxygen-containing gas supply passage 14a. The oxygen-containing gas is discharged from the plurality of power generation cells 10 through the oxygen-containing gas discharge passage 14b. The fuel gas is supplied to the plurality of power generation cells 10 from the fuel gas supply passage 16a. The fuel gas is discharged from the plurality of power generation cells 10 through the fuel gas discharge passage 16b. The coolant is supplied to the plurality of power generation cells 10 through the coolant supply passage 18a. The coolant is discharged from the plurality of power generation cells 10 through the coolant discharge passage 18b.

One end of the longer side (one end on the arrow B1 side) of the power generation cell 10 is provided with the oxygen-containing gas supply passage 14a, the coolant discharge passage 18b, and the fuel gas discharge passage 16b. The oxygen-containing gas supply passage 14a, the coolant discharge passage 18b, and the fuel gas discharge passage 16b are arranged along the shorter side of the power generation cell 10 (arrow C direction).

The oxygen-containing gas flows through the oxygen-containing gas supply passage 14a in the direction indicated by the arrow A2. The coolant flows through the coolant discharge passage 18b in the direction indicated by the arrow A1. The fuel gas flows through the fuel gas discharge passage 16b in the direction indicated by the arrow A1.

The other end of the longer side (the other end on the arrow B2 side) of the power generation cell 10 is provided with the fuel gas supply passage 16a, the coolant supply passage 18a, and the oxygen-containing gas discharge passage 14b. The fuel gas supply passage 16a, the coolant supply passage 18a, and the oxygen-containing gas discharge passage 14b are arranged in the arrow C direction.

The fuel gas flows through the fuel gas supply passage 16a in the direction indicated by the arrow A2. The coolant flows through the coolant supply passage 18a in the direction indicated by the arrow A2. The oxygen-containing gas flows through the oxygen-containing gas discharge passage 14b in the direction indicated by the arrow A1.

The oxygen-containing gas supply passage 14a, the oxygen-containing gas discharge passage 14b, the fuel gas supply passage 16a, and the fuel gas discharge passage 16b are reactant gas passages through which the reactant gas (oxygen-containing gas or fuel gas used for power generation) flows. The positions, shapes, and sizes of the oxygen-containing gas supply passage 14a, the oxygen-containing gas discharge passage 14b, the fuel gas supply passage 16a, the fuel gas discharge passage 16b, the coolant supply passage 18a, and the coolant discharge passage 18b may be set appropriately depending on required specifications.

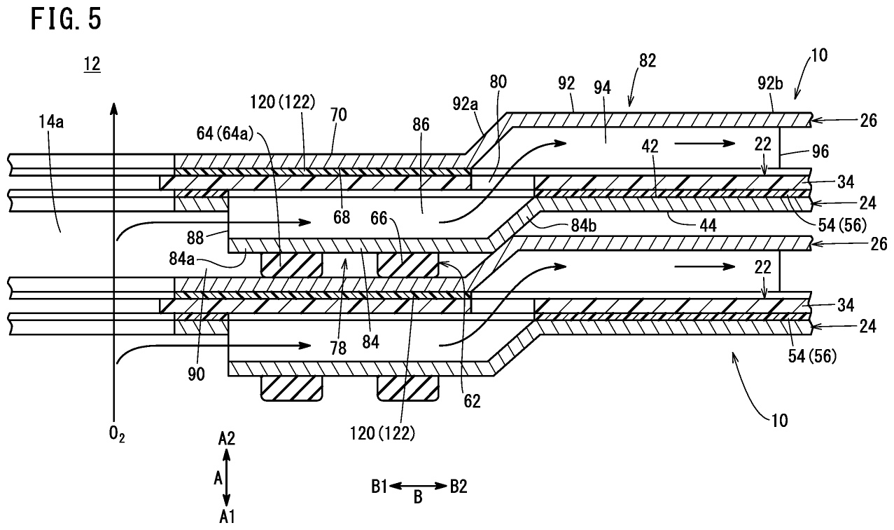

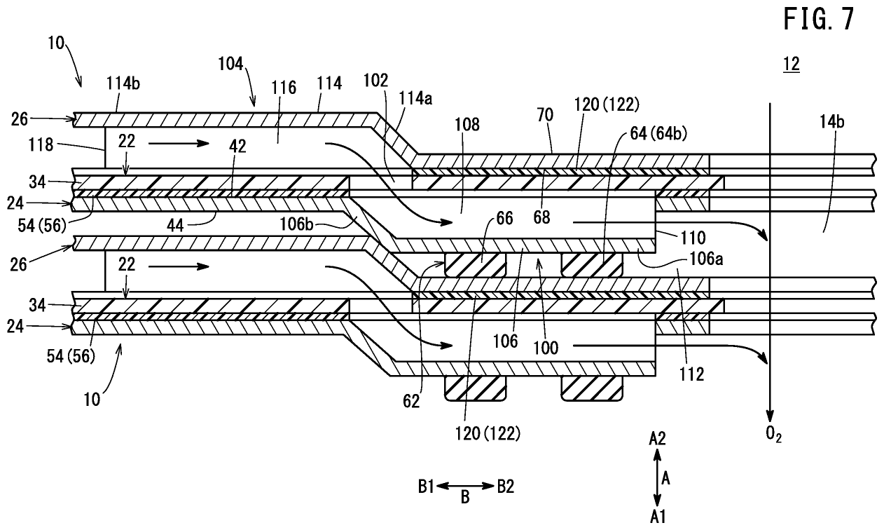

The power generation cell 10 includes a resin-framed membrane electrode assembly 22, a first separator 24, and a second separator 26. The first separator 24 is disposed on one surface (surface on the arrow A1 side) of the resin-framed membrane electrode assembly 22. The second separator 26 is disposed on the other surface (surface on the arrow A2 side) of the resin-framed membrane electrode assembly 22. The first separator 24 and the second separator 26 sandwich the resin-framed membrane electrode assembly 22 in the arrow A direction. In a state where the plurality of power generation cells 10 are stacked one another, the first separator 24 is in contact with the adjacent second separator 26 (see FIGS. 5 and 7).

The resin-framed membrane electrode assembly 22 includes a membrane electrode assembly 32 (MEA) and a resin frame member 34 (resin frame). The membrane electrode assembly 32 includes an electrolyte membrane 36, a first electrode 38, and a second electrode 40. The electrolyte membrane 36 is, for example, a solid polymer electrolyte membrane (cation exchange membrane). The solid polymer electrolyte membrane is formed by impregnating a thin membrane of perfluorosulfonic acid with water, for example. As the electrolyte membrane 36, an HC (hydrocarbon)-based electrolyte can be used in addition to the fluorine-based electrolyte. The electrolyte membrane 36 is sandwiched between the first electrode 38 and the second electrode 40.

The first electrode 38 provided on one surface (surface on the arrow A1 side) of the electrolyte membrane 36 is an anode. The second electrode 40 provided on the other surface (surface on the arrow A2 side) of the electrolyte membrane 36 is a cathode. The first separator 24 is disposed so as to face the first electrode 38. The second separator 26 is disposed so as to face the second electrode 40.

The fuel gas flowing through the fuel gas supply passage 16a is guided to flow between the first separator 24 and the resin-framed membrane electrode assembly 22, and is supplied to the first electrode 38. The oxygen-containing gas flowing through the oxygen-containing gas supply passage 14a is guided to flow between the second separator 26 and the resin-framed membrane electrode assembly 22, and is supplied to the second electrode 40. The power generation cell 10 generates power by the fuel gas supplied to the first electrode 38 and the oxygen-containing gas supplied to the second electrode 40.

The fuel gas flowing between the first separator 24 and the resin-framed membrane electrode assembly 22 is guided to the fuel gas discharge passage 16b. The oxygen-containing gas flowing between the second separator 26 and the resin-framed membrane electrode assembly 22 is guided to the oxygen-containing gas discharge passage 14b. The coolant supplied to the coolant supply passage 18a flows between the first separator 24 and the adjacent second separator 26, and then flows through the coolant discharge passage 18b.

The first electrode 38 includes a first electrode catalyst layer and a first gas diffusion layer. The first electrode catalyst layer is bonded to one surface of the electrolyte membrane 36. The first gas diffusion layer is laminated on the first electrode catalyst layer. The first electrode catalyst layer includes, for example, porous carbon particles with platinum alloy supported on surfaces thereof. The porous carbon particles are uniformly coated together with the ion conductive polymer binder on the surface of the first gas diffusion layer.

The second electrode 40 includes a second electrode catalyst layer and a second gas diffusion layer. The second electrode catalyst layer is bonded to another surface of the electrolyte membrane 36. The second gas diffusion layer is laminated on the second electrode catalyst layer. The second electrode catalyst layer includes, for example, porous carbon particles with platinum alloy supported on surfaces thereof. The porous carbon particles are uniformly coated together with the ion conductive polymer binder on the surface of the second gas diffusion layer. Each of the first gas diffusion layer and the second gas diffusion layer comprises a carbon paper, a carbon cloth, etc.

The resin frame member 34 is a frame-shaped sheet surrounding the outer periphery of the membrane electrode assembly 32. The resin frame member 34 is an electrically insulating member. Examples of materials of the resin frame member 34 include PPS (polyphenylene sulfide), PPA (polyphthalamide), PEN (polyethylene naphthalate), PES (polyethersulfone), LCP (liquid crystal polymer), PVDF (polyvinylidene fluoride), a silicone resin, a fluororesin, m-PPE (modified polyphenylene ether) resin, PET (polyethylene terephthalate), PBT (polybutylene terephthalate), or modified polyolefin.

The resin frame member 34 of the resin-framed membrane electrode assembly 22 may be formed by extending the electrolyte membrane 36 outward from the outer peripheries of the first electrode 38 and the second electrode 40.

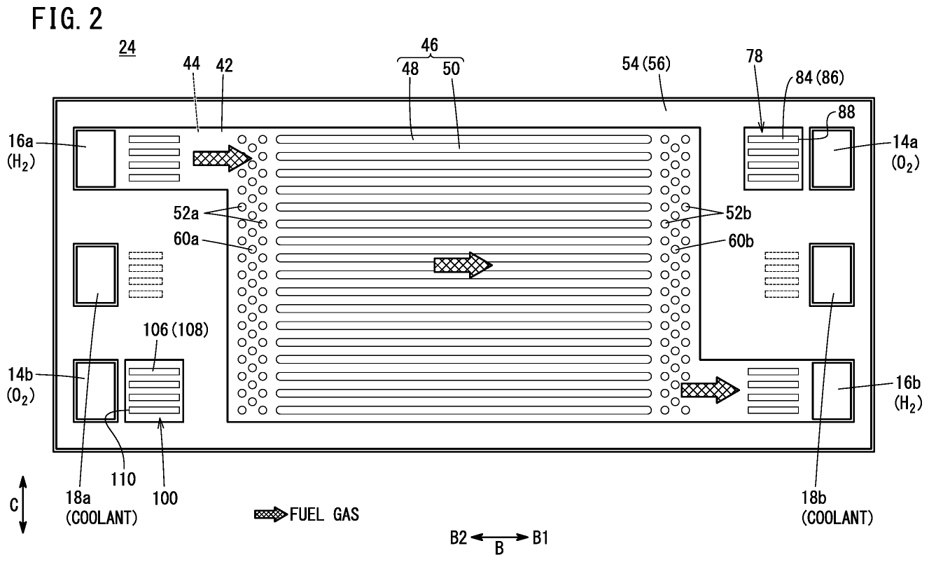

As shown in FIGS. 1 and 2, the first separator 24 is formed in a plate shape. The first separator 24 is, for example, a thin metal plate such as a steel plate, a stainless steel plate, or an aluminum plate. The first separator 24 may be subjected to an anti-corrosion treatment. The first separator 24 is formed in a rectangular shape. The first separator 24 is provided with the oxygen-containing gas supply passage 14a, the coolant discharge passage 18b, and the fuel gas discharge passage 16b in one marginal end portion (marginal end portion on the arrow B1 side). The first separator 24 is provided further with the fuel gas supply passage 16a, the coolant supply passage 18a, and the oxygen-containing gas discharge passage 14b in another marginal end portion (marginal end portion on the arrow B2 side). The first separator 24 is formed by pressing a metal plate.

As shown in FIG. 2, the first separator 24 has a front surface 42 facing the resin-framed membrane electrode assembly 22, and a back surface 44 facing the second separator 26 of the power generation cell 10 adjacent to the first separator 24. A first gas flow field 46, which is one of the reactant gas flow fields, is formed on the surface 42 of the first separator 24. The first gas flow field 46 is a fuel gas flow field for allowing the fuel gas to flow along the first electrode 38.

The first gas flow field 46 includes a plurality of first flow field ridges 48 and a plurality of first flow field grooves 50. The first flow field ridges 48 and the first flow field grooves 50 are alternately provided in the arrow C direction. Each of the first flow field ridges 48 and the first flow field grooves 50 extend linearly in the arrow B direction. Each of the first flow field ridges 48 and the first flow field grooves 50 may extend in a wave form in the arrow B direction. The first gas flow field 46 is connected to the fuel gas supply passage 16a and the fuel gas discharge passage 16b.

An inlet buffer portion 52a is provided between the fuel gas supply passage 16a and the first gas flow field 46. The inlet buffer portion 52a includes a plurality of bosses arranged at intervals in the arrow C direction. The bosses bulge from the back surface 44 toward the front surface 42 of the first separator 24 (in the direction indicated by the arrow A2 in FIG. 1).

An outlet buffer portion 52b is provided between the fuel gas discharge passage 16b and the first gas flow field 46. The outlet buffer portion 52b includes a plurality of bosses arranged at intervals in the arrow C direction. The bosses bulge from the back surface 44 toward the front surface 42 of the first separator 24 (in the direction indicated by the arrow A2 in FIG. 1).

As shown in FIG. 2, a first adhesive layer 54 for bonding the first separator 24 and the resin frame member 34 to each other is provided on the surface 42 of the first separator 24. The first adhesive layer 54 is formed of an adhesive 56 that blocks the flows of the oxygen-containing gas, the fuel gas, and the coolant.

The first adhesive layer 54 is formed by, for example, applying an adhesive 56 in a liquid form to the surface 42 of the first separator 24. The first adhesive layer 54 may be formed by applying the adhesive 56 in the liquid form to one surface (surface facing the first separator 24) of the resin frame member 34 (see FIG. 1). The first adhesive layer 54 may be formed by sandwiching an adhesive sheet of a predetermined shape made of the adhesive 56 between the first separator 24 and the resin frame member 34.

The first adhesive layer 54 individually surrounds the oxygen-containing gas supply passage 14a, the oxygen-containing gas discharge passage 14b, the coolant supply passage 18a, and the coolant discharge passage 18b. The first adhesive layer 54 surrounds a continuous flow path including the fuel gas supply passage 16a, the first gas flow field 46, and the fuel gas discharge passage 16b.

As shown in FIG. 1, a first coolant flow field 58 is formed on the back surface 44 of the first separator 24. The first coolant flow field 58 has a shape of a back surface of the first gas flow field 46. An inlet buffer portion 60a is provided between the first coolant flow field 58 and the coolant supply passage 18a. The inlet buffer portion 60a includes a plurality of bosses arranged at intervals in the arrow C direction. The bosses bulge from the front surface 42 of the first separator 24 toward the back surface 44 (in the direction indicated by the arrow A1 in FIG. 1).

An outlet buffer portion 60b is provided between the first coolant flow field 58 and the coolant discharge passage 18b. The outlet buffer portion 60b includes a plurality of bosses arranged at intervals in the arrow C direction. The bosses bulge from the front surface 42 of the first separator 24 toward the back surface 44 (in the direction indicated by the arrow A1 in FIG. 1).

A seal member 62 is provided on the back surface 44 of the first separator 24 to prevent leakage of the oxygen-containing gas, the fuel gas, and the coolant to the outside. The seal member 62 is brought into close contact with the back surface 70 of the second separator 26 in a state where the seal member 62 is elastically deformed by stacking the plurality of power generation cells 10 and applying a tightening load (see FIGS. 5 and 7). The seal member 62 is made of an elastic resin material. Specifically, the seal member 62 is made of a rubber material.

The seal member 62 includes a plurality of passage seals 64 and a flow field seal 66. The plurality of passage seals 64 individually surround the oxygen-containing gas supply passage 14a, the oxygen-containing gas discharge passage 14b, the fuel gas supply passage 16a, and the fuel gas discharge passage 16b. The flow field seal 66 surrounds a continuous flow path including the coolant supply passage 18a, the first coolant flow field 58, and the coolant discharge passage 18b.

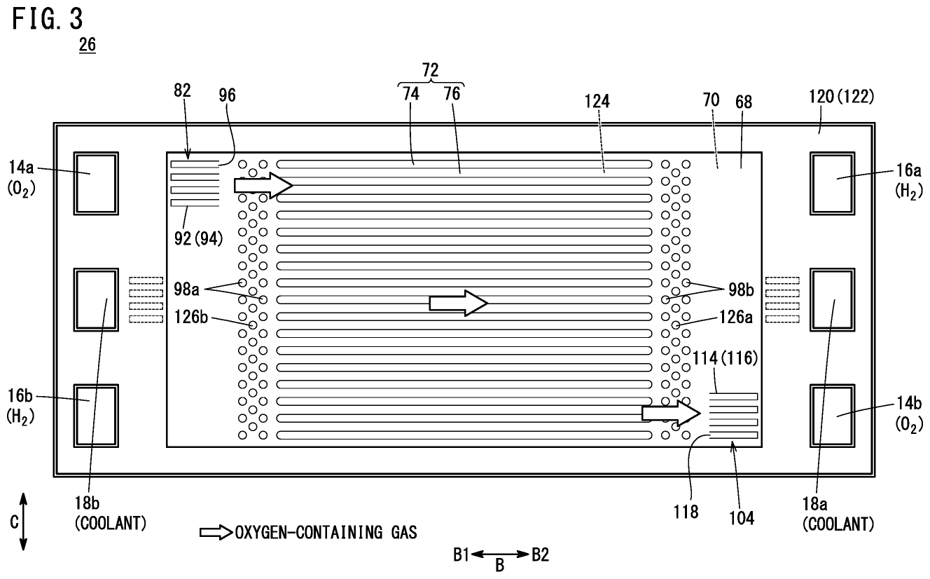

As shown in FIGS. 1 and 3, the second separator 26 is formed in a plate shape. The second separator 26 is, for example, a thin metal plate such as a steel plate, a stainless steel plate, or an aluminum plate. The second separator 26 may be subjected to an anti-corrosion treatment. The second separator 26 is formed in a rectangular shape. The second separator 26 is provided with the oxygen-containing gas supply passage 14a, the coolant discharge passage 18b, and the fuel gas discharge passage 16b in one marginal end portion (marginal end portion on the arrow B1 side). The second separator 26 is provided further with the fuel gas supply passage 16a, the coolant supply passage 18a, and the oxygen-containing gas discharge passage 14b in another marginal end portion (marginal end portion on the arrow B2 side). The second separator 26 is formed by pressing a metal plate.

As shown in FIG. 3, the second separator 26 has a front surface 68 facing the resin-framed membrane electrode assembly 22, and a back surface 70 facing the first separator 24 of the adjacent power generation cell 10. A second gas flow field 72, which is the other reactant gas flow field, is formed on the front surface 68 of the second separator 26. The second gas flow field 72 is an oxygen-containing gas flow field for allowing the oxygen-containing gas to flow along the second electrode 40.

The second gas flow field 72 includes a plurality of second flow field ridges 74 and a plurality of second flow field grooves 76. The second flow field ridges 74 and the second flow field grooves 76 are alternately provided in the arrow C direction. Each of the second flow field ridges 74 and the second flow field grooves 76 extend linearly in the arrow B direction. Each of the second flow field ridges 74 and the second flow field grooves 76 may extend in a wave form in the arrow B direction.

As shown in FIG. 1, the second gas flow field 72 is connected to the oxygen-containing gas supply passage 14a through the first connection flow path 78, the first through-hole 80, and the introduction flow path 82. As shown in FIGS. 1 and 2, the first connection flow path 78 is provided in the first separator 24. The first connection flow path 78 is positioned on the arrow B2 side of the oxygen-containing gas supply passage 14a. The first connection flow path 78 is surrounded by the first adhesive layer 54 (refer to FIG. 2).

As shown in FIGS. 2, 4 and 5, the first connection flow path 78 includes a plurality of first tunnels 84. The plurality of first tunnels 84 are arranged at intervals in the arrow C direction. The first tunnels 84 extend in the arrow B direction. The first tunnels 84 bulge from the front surface 42 toward the back surface 44 of the first separator 24 (see FIG. 5). First inner holes 86 through which the oxygen-containing gas flows are formed in the first tunnels 84.

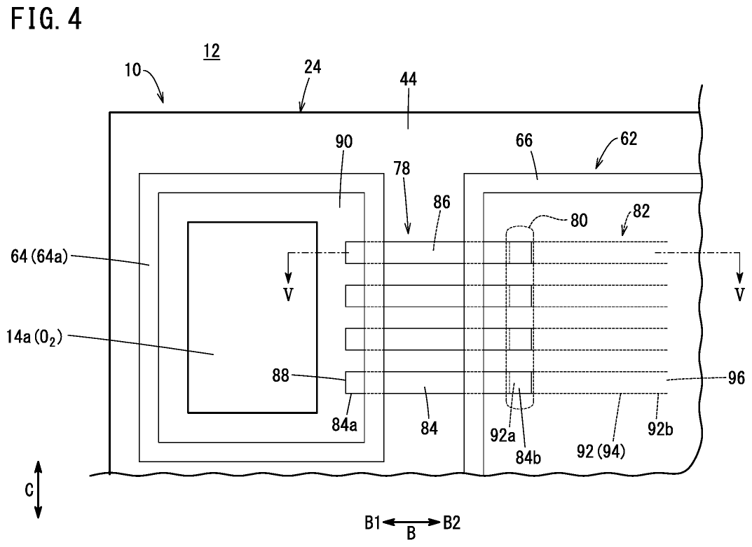

As shown in FIGS. 4 and 5, the first tunnels 84 are positioned on the arrow B2 side of the oxygen-containing gas supply passage 14a. On the outer surface of the first tunnels 84, the passage seal 64 surrounding the oxygen-containing gas supply passage 14a and the flow field seal 66 are provided. In the following description, the passage seal 64 surrounding the oxygen-containing gas supply passage 14a will be referred to as the passage seal 64a.

One ends 84a (ends in the direction indicated by the arrow B1) of the first tunnels 84 are positioned in the area surrounded by the passage seal 64. At the one ends 84a of the first tunnels 84, first openings 88 in communication with the first inner holes 86 are formed. The first openings 88 are connected to a first communication space 90 defined by the oxygen-containing gas supply passage 14a and the passage seal 64. The other ends 84b (ends in the direction indicated by the arrow B2) of the first tunnels 84 are positioned in the area surrounded by the flow field seal 66.

As shown in FIGS. 1 and 5, the first through-hole 80 is formed in the resin frame member 34. The first through-hole 80 is a slit extending in the arrow C direction. When viewed from the stacking direction of the power generation cells 10, the first through-hole 80 overlaps the other ends 84b of the first tunnels 84 (see FIG. 4).

As shown in FIGS. 1 and 3, the introduction flow path 82 is provided in the second separator 26. The introduction flow path 82 is positioned between the oxygen-containing gas supply passage 14a and the second gas flow field 72. The introduction flow path 82 includes a plurality of second tunnels 92.

As shown in FIGS. 3 to 5, the plurality of second tunnels 92 are arranged at intervals in the arrow C direction. The second tunnels 92 extend in the arrow B direction. As shown in FIG. 5, the second tunnels 92 bulge from the front surface 68 toward the back surface 70 of the second separator 26. Second inner holes 94 through which the oxygen-containing gas flows are formed in the second tunnels 92. The second inner holes 94 of the second tunnels 92 communicate with the first inner holes 86 of the first tunnels 84 via the first through-hole 80.

As shown in FIG. 4, when viewed from the stacking direction of the power generation cells 10, one ends 92a (ends in the arrow B1 direction) of the second tunnels 92 overlap the first through-hole 80. In other words, when viewed from the stacking direction of the power generation cells 10, the other ends 84b of the first tunnels 84 overlap the one ends 92a of the second tunnels 92 and the first through-hole 80. Second openings 96 toward the arrow B2 direction are formed on the other ends 92b (ends in the arrow B2 direction) of the second tunnels 92 (see FIGS. 4 and 5).

As shown in FIG. 3, an inlet buffer portion 98a is provided between the introduction flow path 82 and the second gas flow field 72. The inlet buffer portion 98a includes a plurality of bosses arranged at intervals in the arrow C direction. The bosses bulge from the back surface 70 toward the front surface 68 of the second separator 26 (in the direction indicated by the arrow A1 in FIG. 1).

As shown in FIG. 1, the second gas flow field 72 is connected to the oxygen-containing gas discharge passage 14b through the second connection flow path 100, the second through-hole 102, and the lead-out flow path 104. As shown in FIGS. 1 and 2, the second connection flow path 100 is provided in the first separator 24. The second connection flow path 100 is positioned on the arrow B1 side of the oxygen-containing gas discharge passage 14b. The second connection flow path 100 is surrounded by the first adhesive layer 54 (see FIG. 2).

As shown in FIGS. 2, 6 and 7, the second connection flow path 100 includes a plurality of third tunnels 106. The plurality of third tunnels 106 are arranged at intervals in the arrow C direction. The third tunnels 106 extend in the arrow B direction. The third tunnels 106 bulge from the front surface 42 toward the back surface 44 of the first separator 24 (see FIG. 7). Third inner holes 108 through which the oxygen-containing gas flows are formed in the third tunnels 106.

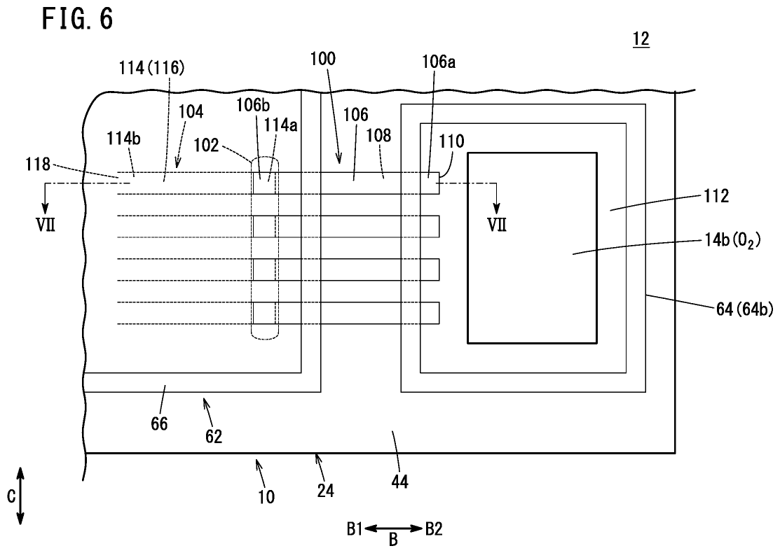

As shown in FIGS. 6 and 7, the third tunnels 106 are positioned on the arrow B1 side of the oxygen-containing gas discharge passage 14b. On the outer surface of the third tunnels 106, the passage seal 64 surrounding the oxygen-containing gas discharge passage 14b and the flow field seal 66 are provided. In the following description, the passage seal 64 surrounding the oxygen-containing gas discharge passage 14b will be referred to as the passage seal 64b.

One ends 106a (ends in the direction indicated by the arrow B2) of the third tunnels 106 are positioned in the area surrounded by the passage seal 64. At the one ends 106a of the third tunnels 106, third openings 110 in communication with the third inner holes 108 are formed. The third openings 110 are connected to a second communication space 112 defined by the oxygen-containing gas discharge passage 14b and the passage seal 64. The other ends 106b (ends in the direction indicated by the arrow B1) of the third tunnels 106 are positioned in the area surrounded by the flow field seal 66.

As shown in FIGS. 1 and 7, the second through-hole 102 is formed in the resin frame member 34. The second through-hole 102 is a slit extending in the arrow C direction. When viewed from the stacking direction of the power generation cells 10, the second through-hole 102 overlaps the other ends 106b of the third tunnels 106 (see FIG. 6).

As shown in FIGS. 1 and 3, the lead-out flow path 104 is provided in the second separator 26. The lead-out flow path 104 is positioned between the oxygen-containing gas discharge passage 14b and the second gas flow field 72. The lead-out flow path 104 includes a plurality of fourth tunnels 114.

As shown in FIGS. 3 to 5, the plurality of fourth tunnels 114 are arranged at intervals in the arrow C direction. The fourth tunnels 114 extend in the arrow B direction. As shown in FIG. 7, the fourth tunnels 114 bulge from the front surface 68 toward the back surface 70 of the second separator 26 (see FIG. 7). Fourth inner holes 116 through which the oxygen-containing gas flows are formed in the fourth tunnels 114. The fourth inner holes 116 of the fourth tunnels 114 communicate with the third inner holes 108 of the third tunnels 106 via the second through-hole 102.

As shown in FIG. 6, when viewed from the stacking direction of the power generation cells 10, one ends 114a (ends in the arrow B2 direction) of the fourth tunnels 114 overlap the second through-hole 102. In other words, when viewed from the stacking direction of the power generation cells 10, the other ends 106b of the third tunnels 106 overlap the one ends 114a of the fourth tunnels 114 and the second through-hole 102. Fourth openings 118 toward the arrow B1 direction are formed on the other ends 114b (ends in the arrow B1 direction) of the fourth tunnels 114.

As shown in FIG. 3, an outlet buffer portion 98b is provided between the lead-out flow path 104 and the second gas flow field 72. The outlet buffer portion 98b includes a plurality of bosses arranged at intervals in the arrow C direction. The bosses bulge from the back surface 70 toward the front surface 68 of the second separator 26 (in the direction indicated by the arrow A1 in FIG. 1).

A second adhesive layer 120 is provided on the front surface 68 of the second separator 26 to bond the second separator 26 and the resin frame member 34 to each other. The second adhesive layer 120 is formed of an adhesive 122 that blocks the oxygen-containing gas, the fuel gas, and the coolant. The adhesive 122 is, for example, the same as the adhesive 56 used for the first adhesive layer 54.

The second adhesive layer 120 is formed by, for example, applying a liquid adhesive 122 to the front surface 68 of the second separator 26. The second adhesive layer 120 may be formed by applying the liquid adhesive 122 to the other surface (the surface facing the second separator 26) of the resin frame member 34. The second adhesive layer 120 may be formed by sandwiching an adhesive sheet of a predetermined shape made of the adhesive 122 between the second separator 26 and the resin frame member 34.

The second adhesive layer 120 individually surrounds the oxygen-containing gas supply passage 14a, the oxygen-containing gas discharge passage 14b, the fuel gas supply passage 16a, the fuel gas discharge passage 16b, the coolant supply passage 18a, and the coolant discharge passage 18b. The second adhesive layer 120 surrounds a continuous flow path including the introduction flow path 82, the second gas flow field 72, and the lead-out flow path 104.

As shown in FIG. 1, a second coolant flow field 124 is formed on the back surface 70 of the second separator 26. The second coolant flow field 124 has a shape of a back surface of the second gas flow field 72. In the state where the plurality of power generation cells 10 are stacked one another, the second coolant flow field 124 is connected to the first coolant flow field 58 of the adjacent power generation cell.

As shown in FIG. 3, an inlet buffer portion 126a is provided between the second coolant flow field 124 and the coolant supply passage 18a. The inlet buffer portion 126a includes a plurality of bosses arranged at intervals in the arrow C direction. The bosses bulge from the front surface 68 of the second separator 26 toward the back surface 70 (in the direction indicated by the arrow A2 in FIG. 1).

An outlet buffer portion 126b is provided between the second coolant flow field 124 and the coolant discharge passage 18b. The outlet buffer portion 126b includes a plurality of bosses arranged at intervals in the arrow C direction. The bosses bulge from the front surface 68 of the second separator 26 toward the back surface 70 (in the direction indicated by the arrow A2 in FIG. 1).

The above-described seal member 62 is not provided on the back surface 70 of the second separator 26.

The power generating cell 10, which is configured as described above, operates in the following manner.

First, as shown in FIG. 1, the fuel gas is supplied to the fuel gas supply passage 16a. The oxygen-containing gas is supplied to the oxygen-containing gas supply passage 14a. The coolant is supplied to the coolant supply passage 18a.

The fuel gas is guided from the fuel gas supply passage 16a into the first gas flow field 46 of the first separator 24. The fuel gas flows through the first gas flow field 46 in the direction indicated by the arrow B1, and is supplied to the first electrode 38 of the membrane electrode assembly 32.

The oxygen-containing gas flows from the oxygen-containing gas supply passage 14a into the second gas flow field 72 through the first communication space 90, a first connection flow path 78 (the first inner holes 86 of the first tunnels 84), the first through-hole 80, and the introduction flow path 82 (the second inner holes 94 of the second tunnels 92). The oxygen-containing gas flows through the second gas flow field 72 in the direction indicated by the arrow B2, and is supplied to the second electrode 40 of the membrane electrode assembly 32.

In the membrane electrode assembly 32, the fuel gas supplied to the first electrode 38 and the oxygen-containing gas supplied to the second electrode 40 are consumed in the first electrode catalyst layer and the second electrode catalyst layer by electrochemical reactions. As a result, power generation is performed.

Then, a remainder of the fuel gas after having been supplied to and partially consumed at the first electrode 38 is discharged as the fuel exhaust gas from the first gas flow field 46 to the fuel gas discharge passage 16b. A remainder of the oxygen-containing gas after having been supplied to and partially consumed at the second electrode 40 is discharged as the oxygen-containing exhaust gas from the second gas flow field 72 to the oxygen-containing gas discharge passage 14b through the lead-out flow path 104 (the fourth inner holes 116 of the fourth tunnels 114), the second through-hole 102, and the second connection flow path 100 (the third inner holes 108 of the third tunnels 106).

The coolant supplied to the coolant supply passage 18a flows into the first coolant flow field 58 and the second coolant flow field 124 formed between the first and second separators 24, 26. The coolant flows in the arrow B direction after being introduced into the first coolant flow field 58 and the second coolant flow field 124. After the coolant cools the membrane electrode assembly 32, the coolant is discharged from the coolant discharge passage 18b.

The power generation cell 10 may be configured by switching the flow paths of the oxygen-containing gas and the fuel gas. In this case, the first electrode 38 serves as the cathode, and the second electrode 40 serves as the anode. The oxygen-containing gas flows through the first gas flow field 46 of the first separator 24, and the fuel gas flows through the second gas flow field 72 of the second separator 26.

### Invention Obtained from Embodiments

The inventions that can be grasped from the above-described embodiment will be described below.

A first aspect of the present invention is a power generation cell (10) including: the resin-framed membrane electrode assembly (22) including the membrane electrode assembly (32) and the resin frame (34) provided on the outer periphery of the membrane electrode assembly; the first separator (24) stacked on the first surface of the resin-framed membrane electrode assembly; the second separator (26) stacked on the second surface of the resin-framed membrane electrode assembly; and the reactant gas passage (14a, 14b) extending through the first separator and the second separator to allow the reactant gas to flow in a stacking direction, wherein the second separator includes the reactant gas flow field (72) configured to allow the reactant gas to flow along the electrode surface of the membrane electrode assembly, the first separator includes the connection flow path (78, 100) in communication with the reactant gas passage, and the resin frame includes the through-hole (80, 102) connecting the reactant gas flow field and the connection flow path to each other.

According to this configuration, the reactant gas flow field formed on the second separator communicates with the reactant gas passage through the through-hole formed in the resin frame member and the connection flow path formed in the first separator. This eliminates the need for the connection flow path formed in the second separator, and thus the degree of freedom in layout of the flow paths formed in the second separator can be increased.

In the above-mentioned power generation cell, the reactant gas passage may include the reactant gas supply passage (14a, 16a) and the reactant gas discharge passage (14b, 16b), the connection flow path may include the first connection flow path (78) connected to the reactant gas supply passage and the second connection flow path (100) connected to the reactant gas discharge passage, and the through-hole may include the first through-hole (80) connecting the reactant gas flow field and the first connection flow path to each other and the second through-hole (102) connecting the reactant gas flow field and the second connection flow path to each other.

According to such a configuration, the degree of freedom in layout of the flow path formed in the second separator can be further increased.

In the above-mentioned power generation cell, the second separator may include the introduction flow path (82) for introducing the reactant gas introduced from the first through-hole into the reactant gas flow field, and the lead-out flow path (104) for discharging the reactant gas having flowed through the reactant gas flow field to the second through-hole.

According to this structure, the reactant gas introduced from the first through-hole can be smoothly introduced to the reactant gas flow field through the introduction flow path. Further, the reactant gas that has flowed through the reactant gas flow field can be smoothly guided to the second through-hole by the lead-out flow path.

The above-mentioned power generation cell may further include the adhesive layer (54) that bonds the first separator and the resin frame to each other, and the adhesive layer may individually surround the reactant gas flow field and the reactant gas passage while blocking the reactant gas.

According to such a configuration, the adhesive layer can seal the reactant gas, and thus the configuration of the power generation cell can be simplified.

Another aspect of the present invention is the fuel cell stack (12) in which a plurality of the above-described power generation cells are stacked.

In the fuel cell stack, the coolant flow field (58, 124) through which the coolant flows, the passage seal (64) surrounding the reactant gas passage, and the flow field seal (66) surrounding the coolant flow field may be provided between the first separator and the second separator adjacent to each other, and the passage seal and the flow field seal may be provided only in the first separator.

According to such a configuration, the passage seal and the flow field seal do not have to be provided in the second separator, and thus the configuration of the second separator can be simplified.

In the fuel cell stack, each of the passage seal and the flow field seal may be made of a rubber material.

It should be noted that the present invention is not limited to the disclosure described above, and various additional or alternative configurations could be adopted therein without departing from the essence and gist of the present invention.

1. A power generation cell comprising:
a resin-framed membrane electrode assembly including a membrane electrode assembly and a resin frame provided on an outer periphery of the membrane electrode assembly;
a first separator stacked on a first surface of the resin-framed membrane electrode assembly;
a second separator stacked on a second surface of the resin-framed membrane electrode assembly; and
a reactant gas passage extending through the first separator and the second separator to allow a reactant gas to flow in a stacking direction, wherein
the second separator includes a reactant gas flow field configured to allow the reactant gas to flow along an electrode surface of the membrane electrode assembly,
the first separator includes a connection flow path in communication with the reactant gas passage, and
the resin frame includes a through-hole connecting the reactant gas flow field and the connection flow path to each other.

2. The power generation cell according to claim 1, wherein
the reactant gas passage includes a reactant gas supply passage and a reactant gas discharge passage,
the connection flow path includes:
a first connection flow path connected to the reactant gas supply passage; and
a second connection flow path connected to the reactant gas discharge passage, and
the through-hole includes:
a first through-hole connecting the reactant gas flow field and the first connection flow path to each other; and
a second through-hole connecting the reactant gas flow field and the second connection flow path to each other.

3. The power generation cell according to claim 2, wherein
the second separator includes:
an introduction flow path for introducing the reactant gas introduced from the first through-hole into the reactant gas flow field, and
a lead-out flow path for discharging the reactant gas having flowed through the reactant gas flow field to the second through-hole.

4. The power generation cell according to claim 1, wherein
an adhesive layer that bonds the first separator and the resin frame to each other, and
the adhesive layer individually surrounds the reactant gas flow field and the reactant gas passage while blocking the reactant gas.

5. A fuel cell stack comprising a plurality of power generation cells according to claim 1 stacked together.

6. The fuel cell stack according to claim 5, wherein between the first separator and the second separator adjacent to each other,
a coolant flow field through which a coolant flows is provided,
a passage seal surrounding the reactant gas passage is provided, and
a flow field seal surrounding the coolant flow field is provided, and
wherein the passage seal and the flow field seal are provided only on the first separator out of the first separator and the second separator.

7. The fuel cell stack according to claim 6, wherein each of the passage seal and the flow field seal is made of a rubber material.
